(19) United States
(12) Patent Application Publication
(10) Pub. No.: US 2007/0224486 A1
(43) Pub. Date: Sep. 27, 2007

(54) DIRECT OXIDATION FUEL CELL AND PRODUCTION METHOD THEREOF

(75) Inventors: Hideyuki UEDA, Osaka (JP); Takashi AKIYAMA, Osaka (JP)

Correspondence Address: STEVENS, DAVIS, MILLER & MOSHER, LLP, 1615 L. STREET N.W., SUITE 850, WASHINGTON, DC, 20036, US

(73) Assignee: Matsushita Electric Industrial Co., Ltd., Osaka (JP)

(21) Appl. No.: 11/688,953

(22) Filed: Mar. 21, 2007

(30) Foreign Application Priority Data
Mar. 22, 2006 (JP) 2006-078404

(51) Int. Cl. H01M 8/02; H01M 8/10; H01M 4/86; H01M 4/88

(52) U.S. Cl. 429/38; 429/30; 429/42; 502/101

(57) ABSTRACT

A direct oxidation fuel cell includes at least one unit cell. The at least one unit cell includes: an anode; a cathode; a hydrogen-ion conductive polymer electrolyte membrane interposed between the anode and the cathode; an anode-side separator having a flow channel for supplying and discharging a fuel to and from the anode; and a cathode-side separator having a gas flow channel for supplying and discharging an oxidant gas to and from the cathode. A water-repellent layer is formed on each side of the electrolyte membrane so as to surround the anode or the cathode. When the MEA is hydrated or when a liquid fuel is supplied to the cell for power generation, the part of the electrolyte membrane surrounding the electrodes is prevented from becoming swollen or deformed rapidly. It is therefore possible to ensure adhesion of the electrodes to the electrolyte membrane.

### FIELD OF THE INVENTION

The present invention relates to a solid polymer electrolyte fuel cell that directly uses fuel without reforming it into hydrogen and to a method for producing the same.

### BACKGROUND OF THE INVENTION

With the advancement of ubiquitous network society, there is a large demand for mobile devices such as cellular phones, notebook personal computers, and digital still cameras. As the power source for these devices, it is desired to put fuel cells into practical use as early as possible, since fuel cells do not need charging and can continuously power such devices if they are supplied with fuel.

Among fuel cells, direct oxidation fuel cells are receiving attention. Direct oxidation fuel cells generate power by directly supplying a liquid fuel, such as methanol or dimethyl ether, into a cell without reforming it into hydrogen, and oxidizing the fuel on an anode. They utilize an organic fuel, which has high theoretical energy density and is easy to store, so system simplification is possible. Thus, active research and development is underway.

A direct oxidation fuel cell has at least one unit cell that includes a membrane electrode assembly (MEA) sandwiched between anode-side and cathode-side separators. The MEA is composed of a hydrogen-ion conductive solid polymer electrolyte membrane sandwiched between an anode and a cathode. Each of the anode and the cathode comprises a catalyst layer and a diffusion layer. This fuel cell generates power by supplying a fuel such as methanol or a methanol aqueous solution to the anode side and supplying an oxidant gas, typically, air, to the cathode side.

The electrode reactions of a direct methanol fuel cell (DMFC), which uses methanol as fuel, are as follows.

Anode: CH₃OH+H₂O→CO₂+6H⁺+6e⁻

Cathode: 3/2O₂+6H⁺+6e⁻→3H₂O

On the anode, methanol reacts with water to produce carbon dioxide, hydrogen ions, and electrons. The hydrogen ions migrate to the cathode through the electrolyte membrane. On the cathode, the hydrogen ions and oxygen combine with electrons that have passed through an external circuit, to produce water.

However, commercialization of such direct oxidation fuel cells has some problems.

One of the problems is “methanol crossover”, which is a phenomenon in which a fuel, such as methanol, supplied to the anode side migrates to the cathode catalyst layer through the electrolyte membrane without reacting. An ion exchange membrane made of perfluoroalkyl sulfonic acid is used as the electrolyte membrane of direct oxidation fuel cells, in view of its hydrogen ion conductivity, heat resistance, and acid resistance. Since this type of electrolyte membrane has a non-cross-linked structure, the hydrophilic and hydrophobic moieties of the membrane undergo a phase separation, so that the fuel such as methanol readily diffuses/moves through the hydrophilic side chain clusters. Such methanol crossover lowers not only fuel utilization but also cathode potential, thereby causing a significant degradation of power generating characteristics.

To reduce such fuel crossover, a large number of proposals have been made on electrolyte membranes. For example, Japanese Laid-Open Patent Publication No. 2005-38620 (hereinafter referred to as Patent Document 1) discloses irradiating the surface of an electrolyte membrane with an electron beam under a reduced pressure to form a modified layer of 5 μm or less. It has been confirmed that this modified layer has a cross-linked structure due to the decomposition of the side chains and sulfonic acid groups and the formation of carboxyl groups. Patent Document 1 states that the modified layer ensures both hydrogen ion conductivity and prevention of fuel crossover. Further, Japanese Laid-Open Patent Publication No. 2002-56857 (hereinafter referred to as Patent Document 2) discloses a structure in which two kinds of electrolyte membranes with different organic fuel permeabilities, for example, an organic electrolyte membrane and an inorganic electrolyte membrane, are laminated with an ion exchanger (a binder layer composed of the same component as that of the organic electrolyte membrane) interposed therebetween, and the organic electrolyte membrane with a higher organic fuel permeability is arranged on the anode side.

Another problem relates to adhesion of a catalyst layer to an electrolyte membrane. An MEA is usually fabricated by using a method called hot pressing. According to this method, an electrolyte membrane is sandwiched between an anode and a cathode, and they are welded and integrally joined at high temperatures of 120 to 150° C. by applying a pressure of approximately 5 to 10 MPa thereto. However, in the above-mentioned case of using an electrolyte membrane with a lower fuel permeability than a polymer electrolyte in a catalyst layer to reduce fuel crossover, sufficient adhesion usually cannot be obtained. Thus, partial separation occurs at the interface between the catalyst layer and the electrolyte membrane. Consequently, the resistance increases at the interface between the electrolyte membrane and the catalyst layer, thereby causing a problem of degradation of power generating characteristics.

To address these problems, for example, Japanese Laid-Open Patent Publication No. 2004-6306 (hereinafter referred to as Patent Document 3) discloses a structure in which an anode catalyst layer containing a first polymer electrolyte and an electrolyte membrane sandwich an adhesive layer containing a second polymer electrolyte that is the same component as that of the electrolyte membrane.

However, it is difficult for the above-mentioned conventional structures to provide a direct oxidation fuel cell with excellent power generating characteristics without lowering fuel utilization efficiency, and there still remain a large number of problems.

In the case of the technique represented by Patent Document 1, the adhesion of the catalyst layer to the modified layer of the electrolyte membrane is not sufficient. For example, when the MEA is hydrated to ensure hydrogen ion conductivity, the part of the electrolyte membrane not facing the catalyst layer becomes swollen and deformed, thereby resulting in complete separation of the catalyst layer from the modified layer.

In the case of the technique represented by Patent Document 2, the inorganic electrolyte membrane on the cathode side has a low hydrogen ion conductivity. When the MEA is hydrated to enhance hydrogen ion conductivity or when an organic fuel is supplied to the cell for power generation, the organic electrolyte membrane and the ion exchanger become swollen and deformed rapidly, thereby resulting in poor adhesion of the ion exchanger to the inorganic electrolyte membrane.

In the case of the technique represented by Patent Document 3, the anode catalyst layer, the adhesive layer, and the electrolyte membrane contain different kinds of polymer electrolytes in different amounts. Hence, the anode catalyst layer, the adhesive layer, and the electrolyte membrane exhibit different degrees of swelling with water or an organic fuel such as methanol. Thus, when the MEA is hydrated or when an organic fuel is supplied to the cell for power generation, partial separation occurs at the interface between the anode catalyst layer, the adhesive layer, and the electrolyte membrane. Particularly when the MEA is hydrated, the part of the electrolyte membrane not facing the catalyst layers becomes swollen and deformed, so that the outer edges of the catalyst layers tend to become separated or damaged. Hence, there is a need to improve the production process in order to stably produce MEAS.

Further, in any case of Patent Documents 1 to 3, the following problem occurs. That is, after the MEA is hydrated, the part of the electrolyte membrane not facing the electrodes becomes shrunk rapidly, so that the gaps between the electrodes and the gaskets are enlarged. Through the enlarged gaps, an organic fuel directly enters the surface of the electrolyte membrane. As a result, fuel crossover increases, thereby leading to a decrease in fuel utilization and power generating characteristics.

The present invention solves these conventional problems and intends to provide a direct oxidation fuel cell with excellent power generating characteristics without lowering fuel utilization efficiency, by suppressing the rapid swelling and deformation of the part of the electrolyte membrane not facing the electrodes upon the hydration of the MEA or the supply of an organic fuel to the cell for power generation, and ensuring the adhesion of the electrodes to the electrolyte membrane.

### BRIEF SUMMARY OF THE INVENTION

A fuel cell of the present invention is a direct oxidation fuel cell including at least one unit cell. The at least one unit cell includes: an anode; a cathode; a hydrogen-ion conductive polymer electrolyte membrane interposed between the anode and the cathode; an anode-side separator having a flow channel for supplying and discharging a fuel to and from the anode; and a cathode-side separator having a gas flow channel for supplying and discharging an oxidant gas to and from the cathode. A water-repellent layer is formed on each side of the electrolyte membrane so as to surround the anode or the cathode.

Preferably, the water repellency of the surface of the water-repellent layer is such that the contact angle with water is 130° or more.

According to the present invention, the water-repellent layer, which has low chemical affinity for water or organic fuel, is formed on each side of the electrolyte membrane so as to surround the anode or cathode. The water-repellent layer is preferably formed on the entire exposed part of the electrolyte membrane surrounding each electrode, i.e., on the surface of the part of the electrolyte membrane not facing each electrode. It is thus difficult for water or organic fuel to penetrate into the part of the electrolyte membrane not facing the electrodes. Hence, when the MEA is hydrated or organic fuel is supplied, the electrolyte membrane is prevented from becoming swollen or deformed rapidly. As a result, it is possible to solve the problem of the poor adhesion of the electrodes to the electrolyte membrane, such as separation or damage of the outer edge of the electrodes, and the problem of increased fuel crossover through the gaps between the electrodes and gaskets at the same time.

When the water-repellent layer has water repellency such that the contact angle with water is 130° or more, it is unlikely to become wet, which is effective in suppressing the penetration of water into the electrolyte membrane. Therefore, the MEA can be hydrated in a higher-temperature environment without impairing the adhesion of the electrodes to the electrolyte membrane, so that the hydrogen ion conductivity of the electrolyte membrane can be enhanced in a short period of time.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF THE SEVERAL VIEWS OF THE DRAWING

FIG. 1 is a schematic longitudinal sectional view of a unit cell of a fuel cell in one embodiment of the present invention;

FIG. 2 is an enlarged sectional view of the main part of the unit cell; and

FIG. 3 is a schematic view showing the structure of a spray application apparatus for forming a water-repellent layer on an electrolyte membrane.

### DETAILED DESCRIPTION OF THE INVENTION

A direct oxidation fuel cell of the present invention includes at least one unit cell. The at least one unit cell includes: an anode; a cathode; a hydrogen-ion conductive polymer electrolyte membrane interposed between the anode and the cathode; an anode-side separator having a flow channel for supplying and discharging a fuel to and from the anode; and a cathode-side separator having a gas flow channel for supplying and discharging an oxidant gas to and from the cathode. A water-repellent layer is formed on each side of the electrolyte membrane so as to surround the anode or the cathode. Preferably, the water-repellent layer is formed so as to surround the electrode such that there is no gap between the water-repellent layer and the electrode. The electrolyte membrane may have some outer area that is not covered by the water-repellent layer.

The water-repellent layer preferably contains at least water-repellent resin fine particles and a water-repellent binding material.

The use of such materials enables formation of a water-repellent layer having an uneven surface and extremely small surface energy on the surface of the electrolyte membrane. It is therefore possible to suppress the penetration of water into the electrolyte membrane effectively.

The water-repellent resin fine particles in the water-repellent layer are preferably fluorocarbon resin fine particles.

Fluorocarbon resin has chemically stable carbon-fluorine (C—F) bonding. Thus, the use of fluorocarbon resin as the water-repellent fine particles permits formation of a “water-repellent” surface, i.e., a surface with small interaction with other molecules. Examples of fluorocarbon resin include polytetrafluoroethylene resin (PTFE), tetrafluoroethylene-hexafluoropropylene copolymer (FEP), polyvinyl fluoride resin (PVF), polyvinylidene fluoride resin (PVDF), and tetrafluoroethylene-perfluoro (alkyl vinyl ether) copolymer (PFA).

The water-repellent binding material in the water-repellent layer is preferably a fluorocarbon resin or a silicone resin.

The use of a fluorocarbon resin or a silicone resin as the water-repellent binding material enables formation of a water-repellent layer with good adhesion to the electrolyte membrane without impairing the water repellency. While the fluorocarbon resin is not particularly limited, it may be a polyvinyl fluoride resin, a polyvinylidene fluoride resin, or the like. The silicone resin may be pure silicone resin or a modified silicone resin if it has siloxane bonding in the molecular skeleton and has methyl groups in the side chains.

The present invention also provides a method for producing the above-mentioned fuel cell of the present invention.

A first method for producing the direct oxidation fuel cell of the present invention includes the steps of:

(a) forming a catalyst layer that comprises catalyst particles and a polymer electrolyte on each side of an electrolyte membrane to obtain a membrane-catalyst layer assembly;

(b) forming a water-repellent layer on the electrolyte membrane so as to surround each of the catalyst layers;

(c) immersing the membrane-catalyst layer assembly with the water-repellent layers in water; and

(d) bonding a diffusion layer to each of the catalyst layers.

In the first production method, before the membrane-catalyst layer assembly is hydrated, each water-repellent layer is formed on the area of the electrolyte membrane on which the catalyst layer is not formed. It is thus possible to enhance the hydrogen ion conductivity in the catalyst layers and electrolyte membrane without causing such bonding problems as separation or damage of the catalyst layers upon hydration.

A second method for producing the direct oxidation fuel cell of the present invention includes the steps of:

(a) forming a water-repellent layer on each side of an electrolyte membrane so as to surround a predetermined area on which a catalyst layer is to be formed;

(b) immersing the electrolyte membrane with the water-repellent layers in water;

(c) forming a catalyst layer that comprises catalyst particles and a polymer electrolyte on the predetermined area on each side of the electrolyte membrane to obtain a membrane-catalyst layer assembly;

(d) immersing the membrane-catalyst layer assembly in water; and

(e) bonding a diffusion layer to each of the catalyst layers.

In the second production method, before the membrane-catalyst layer assembly is fabricated, each water-repellent layer is formed on the electrolyte membrane, followed by hydration. Hence, the part of the electrolyte membrane facing the catalyst layers can be sufficiently hydrated near the surface thereof, without being affected by the swelling and deformation of the part of the electrolyte membrane not facing the catalyst layers. It is thus possible to improve the adhesion of the catalyst layers to the electrolyte membrane. Also, since the hydration process can be performed right after the membrane-catalyst layer assembly is fabricated, it is possible to minimize the structural change of the electrolyte component due to the evaporation of water in the electrolyte membrane and the catalyst layers. Consequently, the hydration time for ensuring hydrogen ion conductivity can be shortened.

In a preferable embodiment of the first and second production methods, the water-repellent layer is formed by a wet application method.

The water-repellent layer can be formed by wet application methods, such as spraying and a doctor blade method, and dry application methods, such as plasma vapor deposition. However, wet application methods are preferable in terms of maintaining the hydrated state of the electrolyte membrane and the catalyst layers.

In another preferable embodiment of the first and second production methods, the water-repellent layer is formed by spraying a paste that contains at least water-repellent resin fine particles and a water-repellent binding material and drying it.

The use of spraying allows small droplets containing water-repellent materials to be deposited on the surface of the electrolyte membrane thinly and evenly. It is thus possible to form a water-repellent layer having an uneven surface and extremely small surface energy without impairing the flexibility of the electrolyte membrane.

As described above, according to the present invention, the water-repellent layer is formed on each side of the electrolyte membrane so as to surround the electrode. It is thus difficult for water or an organic fuel to penetrate into the part of the electrolyte membrane surrounding the electrodes. Hence, when the MEA is hydrated to ensure hydrogen ion conductivity or when an organic fuel is supplied, the electrolyte membrane can be prevented from becoming swollen or deformed rapidly. As a result, it is possible to solve the problem of the poor adhesion of the electrodes to the electrolyte membrane, such as separation or damage of the outer edge of the electrodes, and the problem of increased fuel crossover through the gaps between the electrodes and gaskets at the same time. Therefore, a direct oxidation fuel cell having excellent power generating characteristics can be provided without lowering fuel utilization efficiency.

Referring now to drawings, an embodiment of the present invention is described.

### EMBODIMENT 1

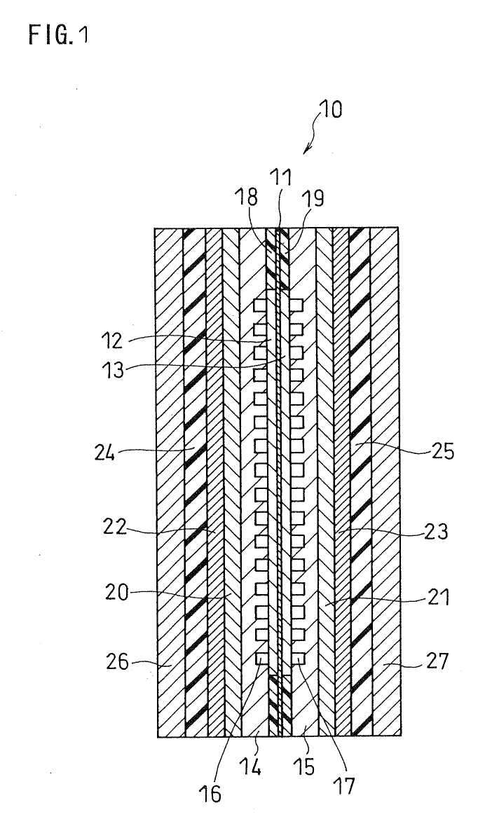

FIG. 1 is a schematic longitudinal sectional view showing the structure of a fuel cell in one embodiment of the present invention. In this example, the fuel cell is composed of one unit cell. A unit cell 10 includes a membrane electrode assembly (MEA) sandwiched between an anode-side separator 14 and a cathode-side separator 15. The MEA includes a hydrogen-ion conductive electrolyte membrane 11 and an anode 12 and a cathode 13 sandwiching the electrolyte membrane 11. The anode-side separator 14 has a flow channel 16, through which a fuel is supplied and discharged, on the anode-facing side thereof. The cathode-side separator 15 has a gas flow channel 17, through which an oxidant gas is supplied and discharged, on the cathode-facing side thereof. Gaskets 18 and 19 are fitted around the anode and the cathode so as to sandwich the electrolyte membrane.

The unit cell 10 further includes current collector plates 20 and 21, heater plates 22 and 23, insulator plates 24 and 25, and end plates 26 and 27 on both sides thereof, and these components are integrally secured with clamping means.

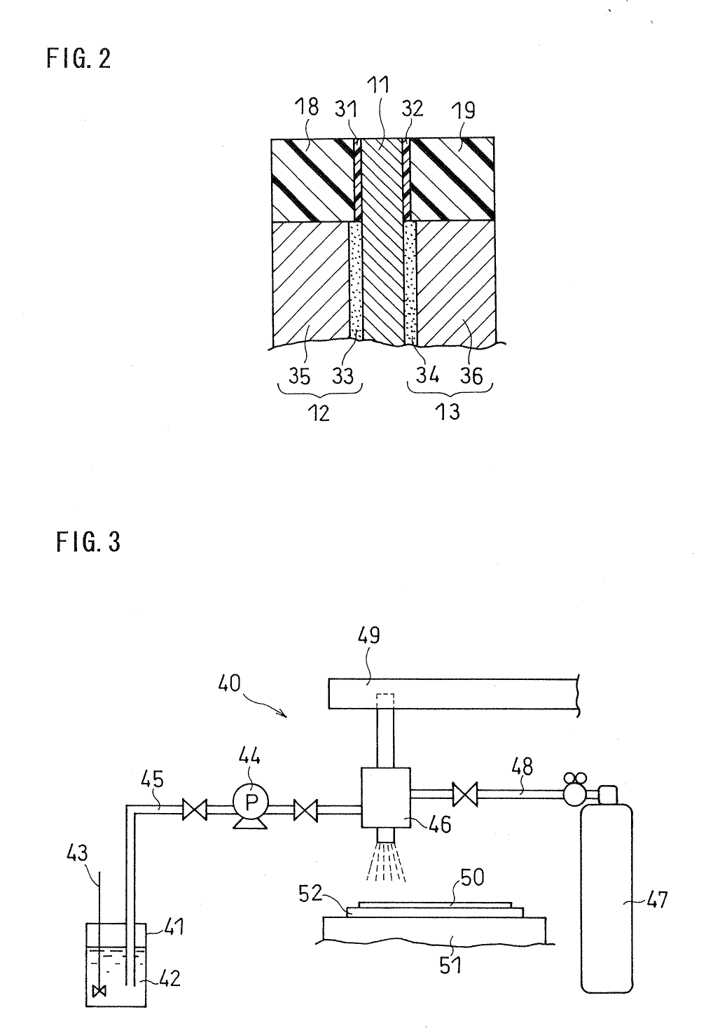

FIG. 2 shows the structure of the main part of the MEA. The anode 12 and the cathode 13 include catalyst layers 33 and 34 in contact with the electrolyte membrane 11 and diffusion layers 35 and 36 on the separator side, respectively. In this example, the anode and the cathode are positioned in the central areas of the electrolyte membrane 11, and water-repellent layers 31 and 32 are formed on the peripheral areas of the electrolyte membrane surrounding the anode and the cathode, respectively. The gaskets 18 and 19 are provided on the water-repellent layers.

The electrolyte membrane 11 may be made of any material that is excellent in hydrogen ion conductivity, heat resistance, and chemical stability, and the material is not particularly limited.

Each of the catalyst layers 33 and 34 is a porous thin film composed mainly of a polymer electrolyte and conductive carbon particles with a catalyst metal carried thereon or catalyst metal particles. The catalyst metal of the anode catalyst layer 33 is a platinum-ruthenium (Pt—Ru) alloy in the form of fine particles, while the catalyst metal of the cathode catalyst layer 34 is Pt in the form of fine particles. The polymer electrolyte may be any material that is excellent in hydrogen ion conductivity, heat resistance, and chemical stability, and the material is not particularly limited.

The substrate of the anode diffusion layer 35 may be a conductive porous material with fuel diffusibility, dischargeability of carbon dioxide produced by power generation, and electronic conductivity, such as carbon paper or carbon cloth. The conductive porous substrate may be subjected to a water repellency treatment by a conventional technique. Further, the surface of the conductive porous substrate on the catalyst layer (33) side may be provided with a water-repellent carbon layer.

The substrate of the cathode diffusion layer 36 may be a conductive porous material with air diffusibility, dischargeability of water produced by power generation, and electronic conductivity, such as carbon paper or carbon cloth. The conductive porous substrate may be subjected to a water repellency treatment by a conventional technique. Further, the surface of the conductive porous substrate on the catalyst layer (34) side may be provided with a water-repellent carbon layer.

The water-repellent layers 31 and 32 are formed from a water repellent material or a water-repellent paste composed mainly of fine particles of a water-repellent resin, such as polytetrafluoroethylene resin, tetrafluoroethylene-hexafluoropropylene copolymer, polyvinyl fluoride resin, polyvinylidene fluoride resin, or tetrafluoroethylene-perfluoro (alkyl vinyl ether) copolymer, and a water-repellent binding material, such as fluorocarbon resin or silicone resin. Preferable exemplary methods of forming these layers include a method of spraying such a water repellent material or paste and a method of applying it by a wet application method using a coater such as a doctor blade.

The use of spraying, in particular, allows small droplets containing water repellent materials to be deposited on the surface of the electrolyte membrane thinly and evenly. It is thus possible to form a water-repellent layer having an uneven surface and extremely small surface energy without impairing the flexibility of the electrolyte membrane.

Also, the surface temperature of the electrolyte membrane to which spraying is applied is preferably 30 to 60° C. In this temperature range, small droplets containing the water repellent materials can be deposited and dried on the application surface while the evaporation of water contained in the electrolyte membrane is suppressed. It is thus possible to prevent the creation of microcracks in the water-repellent layer. However, if the surface temperature of the electrolyte membrane exceeds 60° C., the evaporation speed of the water contained in the electrolyte membrane becomes high, which is not preferable. On the other hand, if it is less than 30° C., the evaporation speed of the volatile component in the paste is too low. Thus, after a layer is formed, a large amount of the solvent evaporates, thereby promoting the creation of microcracks, which is not preferable.

The separators 14 and 15 may be any material with gas tightness, electronic conductivity, and electrochemical stability, and the material is not particularly limited. Also, the shape of the flow channels 16 and 17 is not particularly limited.

FIG. 3 is a schematic view showing the structure of a spray application apparatus for forming the water-repellent layers 31 and 32 of the present invention on the electrolyte membrane A spray application apparatus 40 has a tank 41 containing a paste 42, which is a homogeneous dispersion of water-repellent resin fine particles in a medium. The paste in the tank is constantly flowing due to the operation of a stirrer 43, and is fed to a spray nozzle 46 through a pipe 45 equipped with a pump 44. Also, nitrogen gas is fed to the spray nozzle 46 as a jet gas from a cylinder 47 through a pipe 48.

The spray nozzle 46, which is attached to an actuator 49, is capable of moving at a given speed in two directions of the X axis and the Y axis. While spraying the paste 42, the spray nozzle 46 moves above an electrolyte membrane 50 on which a water-repellent layer is intended to be formed, so that the paste 42 is evenly applied onto the electrolyte membrane 50. At this time, the electrolyte membrane 50 is heated by a heater 52 on a workbench 51 such that the surface temperature is 30 to 60° C.

The present invention is hereinafter described in detail by way of Examples and Comparative Examples, which are not to be construed as limiting in any way the present invention.

### EXAMPLE 1

Anode catalyst-carrying particles were prepared by placing 30% by weight of Pt and 30% by weight of Ru, each having a mean particle size of 30 Å, on conductive carbon particles of carbon black with a mean primary particle size of 30 nm (ketjen black EC available from Mitsubishi Chemical Corporation). Also, cathode catalyst-carrying particles were prepared by placing 50% by weight of Pt with a mean particle size of 30 Å on the same ketjen black EC. A dispersion of each of the anode and cathode catalyst-carrying particles in an isopropanol aqueous solution was mixed with a dispersion of a polymer electrolyte in an isopropanol aqueous solution, and the mixture was highly dispersed in a bead mill. In this way, an anode catalyst paste and a cathode catalyst paste were prepared. The weight ratio between the catalyst-carrying particles and the polymer electrolyte in each catalyst paste was 1:1. The polymer electrolyte used was a perfluorocarbon sulfonic acid ionomer (Flemion available from Asahi Glass Co., Ltd.). Each catalyst paste was applied onto a polytetrafluoroethylene sheet (Naflon PTFE sheet available from NICHIAS Corporation) with a doctor blade and dried in the air at room temperature for 6 hours. In this way, an anode catalyst layer and a cathode catalyst layer were formed.

The sheet with the anode catalyst layer and the sheet with the cathode catalyst layer were cut to a size of 6 cm×6 cm. The central part of an electrolyte membrane was sandwiched between these two sheets such that the respective catalyst layers were positioned inward. This combination was hot pressed at 130° C. at 82 kg/cm² for 3 minutes. The electrolyte membrane used was an ion exchange membrane of perfluoroalkyl sulfonic acid (Nafion 112 available from E.I. Du Pont de Nemours & Company). Thereafter, the polytetrafluoroethylene sheets were removed from the assembly thus obtained, so that the anode catalyst layer and the cathode catalyst layer were formed on the central part of the electrolyte membrane. The amount of Pt catalyst in each of the anode and cathode catalyst layers was 2.2 mg/cm².

Next, a paste for forming a water-repellent layer was prepared by diluting a super-water-repellent material composed mainly of polytetrafluoroethylene resin fine particles and a silicone resin (HIREC450 available from NTT Advanced Technology Corporation) with isooctane. This paste was filled in the tank 42 of the spray application apparatus 40 of FIG. 3. With the catalyst layer of the electrolyte membrane covered with a protective cover, the paste was sprayed on the exposed part of the electrolyte membrane, i.e., the peripheral part surrounding the catalyst layer. The surface temperature of the electrolyte membrane was 50° C. during the spray application. The paste was then dried at room temperature for approximately 1 hour to form a water-repellent layer. In this way, a 15-μm-thick water-repellent layer was formed on each side of the electrolyte membrane in the area on which no catalyst layer was formed.

The membrane-catalyst layer assembly with the water-repellent layers was immersed in deionized water of 70° C. for 6 hours.

Subsequently, the water on the surface of the membrane-catalyst layer assembly was wiped off with a Kimwipe S-200 (available from Nippon Paper Crecia Co., Ltd.). A diffusion layer of 6 cm×6 cm was then placed on each of the anode and cathode catalyst layers, and they were hot pressed at 130° C. and 41 kg/cm² for 2 minutes. As the substrate of each diffusion layer, carbon paper (TGP-H090 available from Toray Industries Inc.) was used, and the surface of the carbon paper on the catalyst layer side was provided with a water-repellent carbon layer of 15 μm in thickness.

Further, gaskets were hot pressed at 135° C. and 41 kg/cm² around the anode and the cathode so as to sandwich the electrolyte membrane for 30 minutes, to produce an MEA.

The MEA was sandwiched between a pair of separators, current collector plates, heaters, insulator plates, and end plates, which had outer dimensions of 12 cm×12 cm, and the entire unit was secured with clamping rods. The clamping pressure was 20 kgf/cm² per separator area. Each of the anode-side and cathode-side separators was made of a 4-mm-thick resin-impregnated graphite plate (G347B available from Tokai Carbon Co., Ltd.) having a serpentine flow channel with a width of 1.5 mm and a depth of 1 mm on the anode-facing or cathode-facing side. The current collector plates were gold-plated stainless steel plates, and the end plates were stainless steel plates.

In this way, a fuel cell A was produced.

### EXAMPLE 2

A fuel cell B was produced in the same manner as in Example 1, except that a dilute solution (FEP concentration 40 wt %) prepared by adding deionized water to a dispersion of tetrafluoroethylene-hexafluoropropylene copolymer resin (ND-10E available from Daikin Industries, Ltd.) was sprayed by using the device of FIG. 3 to form water-repellent layers.

### EXAMPLE 3

A fuel cell C was produced in the same manner as in Example 1, except that a hydrocarbon-type polymer electrolyte membrane (thickness 60 μm) composed mainly of sulfonated polyether ether ketone (PEEK) was used as the electrolyte membrane, and that after the formation of the water-repellent layers, the membrane-catalyst layer assembly was immersed in deionized water for 12 hours.

### EXAMPLE 4

A fuel cell D was produced in the same manner as in Example 1, except that a hydrocarbon-type polymer electrolyte membrane (thickness 60 μm) composed mainly of sulfonated polyether ether ketone (PEEK) was used as the electrolyte membrane, and that the step of forming water-repellent layers on the electrolyte membrane in areas excluding the areas on which catalyst layers are to be formed and the step of immersing the electrolyte membrane with the water-repellent layers in deionized water of 70° C. for 1 hour were added before the step of hot pressing the catalyst layers to the electrolyte membrane.

### COMPARATIVE EXAMPLE 1

A fuel cell E was produced in the same manner as in Example 1, except that no water-repellent layers were formed on the electrolyte membrane.

### COMPARATIVE EXAMPLE 2

A fuel cell F was produced in the same manner as in Example 2, except that no water-repellent layers were formed on the electrolyte membrane.

The fuel cells A to D of Examples and the fuel cells E and F of Comparative Examples were subjected to the following evaluation test. Table 1 shows the results.

TABLE 1

| | | Main component | | | | |
|---|---|---|---|---|---|---|
| | When | of paste for | | Contact angle | Current-voltage | Current-voltage |
| | water-repellent | water-repellent | Electrolyte | with water | characteristics 1 | characteristics 2 |
| | layer was formed | layer | membrane | [deg.] | [V] | [V] |
| Battery A | Formed after | HIREC 450 | Nafion 112 | 163 | 0.428 | 0.402 |
| | formation of | | | | | |
| | catalyst layer | | | | | |
| Battery B | Formed after | ND-10E | Nafion 112 | 125 | 0.422 | 0.391 |
| | formation of | | | | | |
| | catalyst layer | | | | | |
| Battery C | Formed after | HIREC 450 | Hydrocarbon-type | 163 | 0.457 | 0.438 |
| | formation of | | polymer membrane | | | |
| | catalyst layer | | | | | |
| Battery D | Formed before | HIREC 450 | Hydrocarbon-type | 163 | 0.472 | 0.459 |
| | formation of | | polymer membrane | | | |
| | catalyst layer | | | | | |
| Battery E | Not formed | | Nafion 112 | 93 | 0.402 | 0.318 |
| Battery F | Not formed | | Hydrocarbon-type | 89 | 0.435 | 0.371 |
| | | | polymer membrane | | | |

### (1) Contact Angle with Water

Deionized water (surface tension 72.8 mN/m) was dropped to the surface of the part of the electrolyte membrane to come into contact with the gasket. After the lapse of 50 msec, the contact angle was measured.

### (2) Current-Voltage Characteristics 1

A 2M methanol aqueous solution was supplied to the anode at a flow rate of 0.4 cc/min, while air was supplied to the cathode at a flow rate of 0.2 L/min. While the cell temperature was kept at 60° C., power was continuously generated at a current density of 150 mA/cm². After the power generation for 8 hours, the effective voltage was measured.

### (3) Current-Voltage Characteristics 2

A 4M methanol aqueous solution was supplied to the anode at a flow rate of 0.2 cc/min, while air was supplied to the cathode at a flow rate of 0.2 L/min. While the cell temperature was kept at 60° C., power was continuously generated at a current density of 150 mA/cm². After the power generation for 8 hours, the effective voltage was measured.

Table 1 clearly indicates the followings. In the case of the fuel cells A to D, the water-repellent layers were formed on the areas of the electrolyte membrane on which no catalyst layers were formed. Thus, it was difficult for water or the methanol aqueous solution to penetrate into these areas of the electrolyte membrane. Hence, when the MEA was hydrated to ensure hydrogen ion conductivity or when the methanol aqueous solution was supplied to the cell for power generation, the electrolyte membrane was prevented from becoming swollen or deformed rapidly. As a result, it was possible to solve the problem of the poor adhesion of the electrodes to the electrolyte membrane, such as separation or damage of the outer edge of the electrodes, and the problem of increased methanol crossover through the gaps between the electrodes and gaskets at the same time. Also, the fuel cells A to D exhibited excellent power generating characteristics even under the operating conditions where the high concentration methanol was supplied at the low air flow rate. In the case of the fuel cell D, in particular, before the membrane-catalyst layer assembly was fabricated, the water-repellent layers were formed on the electrolyte membrane, followed by hydration. Hence, the part of the electrolyte membrane on which the catalyst layers were to be formed could be sufficiently hydrated near the surface thereof, without being affected by the swelling and deformation of the peripheral part of the electrolyte membrane. As a result, the adhesion of the catalyst layers to the electrolyte membrane was further improved and the power generating characteristics were significantly enhanced.

Contrary to this, in the case of the fuel cells E and F, no water-repellent layers were formed on the peripheral part of the electrolyte membrane surrounding the catalyst layers. Thus, upon the hydration of the MEA and the supply of the methanol aqueous solution to the cell for power generation, the peripheral part of the electrolyte membrane was not prevented from becoming swollen and deformed rapidly, thereby resulting in a decrease in adhesion of the electrodes to the electrolyte membrane and an increase in methanol crossover through the gaps between the electrodes and the gaskets. Probably for this reason, when the high concentration methanol was supplied, the power generating characteristics degraded.

The fuel cell of the present invention can directly use a fuel, such as methanol or dimethyl ether, without reforming it into hydrogen and is therefore useful as the power source for portable small-sized electronic devices, such as cellular phones, personal digital assistants (PDAs), notebook PCs, and video cameras. It is also applicable as the power source for electric scooters, etc.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

1. A direct oxidation fuel cell comprising at least one unit cell, said at least one unit cell comprising: an anode; a cathode; a hydrogen-ion conductive polymer electrolyte membrane interposed between said anode and said cathode; an anode-side separator having a flow channel for supplying and discharging a fuel to and from said anode; and a cathode-side separator having a gas flow channel for supplying and discharging an oxidant gas to and from said cathode,
wherein a water-repellent layer is formed on each side of said electrolyte membrane so as to surround said anode or said cathode.

2. The direct oxidation fuel cell in accordance with claim 1, wherein the contact angle between a surface of said water-repellent layer and water is 130° or more.

3. The direct oxidation fuel cell in accordance with claim 1, wherein said water-repellent layer comprises at least water-repellent resin fine particles and a water-repellent binding material.

4. The direct oxidation fuel cell in accordance with claim 3, wherein said water-repellent resin fine particles are fluorocarbon resin fine particles.

5. The direct oxidation fuel cell in accordance with claim 3, wherein said water-repellent binding material comprises a fluorocarbon resin or a silicone resin.

6. A method for producing a direct oxidation fuel cell, comprising the steps of:
forming a catalyst layer that comprises catalyst particles and a polymer electrolyte on each side of an electrolyte membrane to obtain a membrane-catalyst layer assembly;
forming a water-repellent layer on said electrolyte membrane so as to surround each of said catalyst layers;
immersing the membrane-catalyst layer assembly with the water-repellent layers in water; and
bonding a diffusion layer to each of said catalyst layers.

7. The method for producing a direct oxidation fuel cell in accordance with claim 6, wherein said step of forming the water-repellent layer comprises the step of applying a paste for forming the water-repellent layer onto said electrolyte membrane and drying it.

8. The method for producing a direct oxidation fuel cell in accordance with claim 6, wherein said step of forming the water-repellent layer comprises the step of spraying a paste that comprises at least water-repellent resin fine particles and a water-repellent binding material on said electrolyte membrane and drying it.

9. A method for producing a direct oxidation fuel cell, comprising the steps of:
forming a water-repellent layer on each side of an electrolyte membrane so as to surround a predetermined area on which a catalyst layer is to be formed;
immersing said electrolyte membrane with said water-repellent layers in water;
forming a catalyst layer that comprises catalyst particles and a polymer electrolyte on said predetermined area on each side of said electrolyte membrane to obtain a membrane-catalyst layer assembly;
immersing the membrane-catalyst layer assembly in water; and
bonding a diffusion layer to each of said catalyst layers.

10. The method for producing a direct oxidation fuel cell in accordance with claim 9, wherein said step of forming the water-repellent layer comprises the step of applying a paste for forming the water-repellent layer onto said electrolyte membrane and drying it.

11. The method for producing a direct oxidation fuel cell in accordance with claim 9, wherein said step of forming the water-repellent layer comprises the step of spraying a paste that comprises at least water-repellent resin fine particles and a water-repellent binding material on said electrolyte membrane and drying it.
